(19) United States
(12) Patent Application Publication
(10) Pub. No.: US 2006/0117748 A1
(43) Pub. Date: Jun. 8, 2006

(54) Circuit arrangement which cools charging air and method for the operation of said type of circuit arrangement

(76) Inventors: Steffen Bundschuh, Stuttgart (DE); Eberhard Pantow, Moglingen (DE); Sarah Parmentier, Gerlingen (DE); Stefan Rogg, Stuttgart (DE)

Correspondence Address: FOLEY AND LARDNER LLP;SUITE 500, 3000 K STREET NW, WASHINGTON, DC, 20007, US

(21) Appl. No.: 10/552,734

(22) PCT Filed: Apr. 8, 2004
(86) PCT No.: PCT/EP04/03797

§ 371 Date: Oct. 11, 2005

(30) Foreign Application Priority Data
Apr. 11, 2003 (DE) 103 17 003.0

(51) Int. Cl. F02B 33/00; F02B 29/04

(52) U.S. Cl. 60/599; 123/563

(57) ABSTRACT

The invention relates to a circuit arrangement (1) comprising a low temperature circuit (2) in order to cool charging air in a motor vehicle, comprising a turbo charger and motor cooling circuit (3) which cools a motor (4). The low temperature circuit (2) can be temporarily coupled to the motor cooling circuit (3) in such a manner that the coolant can pass from one circuit (2, 3) to another (2, 3) and back again. The invention also relates to a method the operation of said type of circuit arrangement (1).

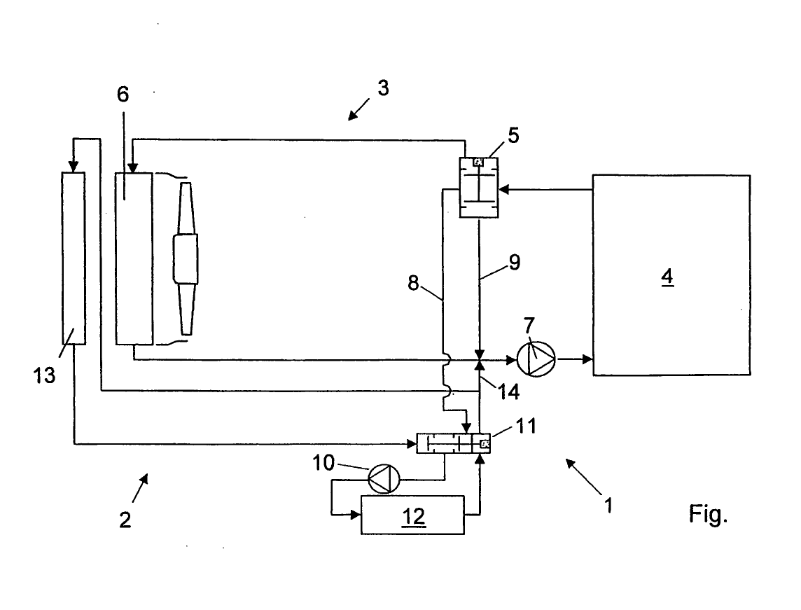

The invention relates to a circuit arrangement which cools charging air in a motor vehicle comprising a turbocharger, according to the preamble of claim 1, and to a method for the operation of said type of circuit arrangement, according to the preamble of claim 6 or 7.

According to the prior art, to increase the power of engines, turbochargers are used in order to compress the air. In this case, however, a heating of the air, designated below as charging air, to temperatures above 100° C. occurs because of compression in the turbocharger. In order to reduce such air heating, air coolers are used which are arranged in the front in the cooling module and serve for cooling the charging air. The charging air in this case flows through a heat exchanger, through which ambient air flows and which is consequently cooled. It is thereby possible to cool the charging air to a temperature which is about 15-50 K above the temperature of the ambient air.

Furthermore, it is known that the cooling of the charging air takes place via a refrigerant circuit, for example a low temperature circuit in which the refrigerant is cooled to very low temperatures. By means of this cold refrigerant, the charging air is cooled down to a predetermined cooling temperature in a charging-air/coolant cooler. For the connection of the low temperature circuit, there are two variants, to be precise an integration of the low temperature circuit into a secondary circuit of the engine cooling system or a design in the form of a separate circuit.

The design as a separate circuit has the advantage that low temperatures can be achieved.

Where the integrated circuit is concerned, an additional pump may be dispensed with if there is appropriate connection. However, there is coupling to the temperature of the main circuit by means of the engine thermostat, so that, in the case of a high outside temperature or in part load operation, the same cooling cannot be achieved as in the case of a separate circuit. Moreover, as regards outlet regulation, that is to say the thermostat is arranged at the engine outlet, the low temperature circuit has to be mounted on the pump pressure side. This increases the pressure in the low temperature cooler, which may lead to problems with regard to fatigue strength.

The object of the invention is to improve a circuit arrangement of the type initially mentioned.

This object is achieved by means of a circuit arrangement having the features of claim 1.

According to the invention, a circuit arrangement with a low temperature circuit for the cooling of charging air in a motor vehicle comprising a turbocharger and an engine cooling circuit for cooling an engine is provided, the low temperature circuit being capable of being temporarily coupled to the engine cooling circuit in such a way that coolant can pass from one circuit into the other circuit and back, with the result that the advantages of a separate arrangement of the low temperature circuit and engine cooling circuit and of a permanently interconnected arrangement of the low temperature circuit and engine cooling circuit are combined.

Preferably, a feedline is provided between the engine cooling circuit and the low temperature circuit. By means of the feed line, which leads preferably from an engine thermostat, arranged in the engine cooling circuit downstream of the engine, as seen in the flow direction, to a mixed thermostat integrated into the low temperature circuit, warm coolant can pass from the engine cooling circuit into the low temperature circuit.

For the return of coolant out of the low temperature circuit into the engine cooling circuit, a feedback line is preferably arranged between the mixed thermostat and the engine thermostat.

The mixed thermostat is preferably an expansion thermostat or an electrically or pneumatically actuable valve.

To operate the circuit arrangement, coolant flows out of the engine cooling circuit into the low temperature circuit preferably during the warm-up of the engine. This serves for accelerating the warm-up.

In the warm state of the engine, that is to say in normal operation, preferably warm coolant can flow out of the engine cooling circuit into the low temperature circuit in order to assist the regeneration of particle filters. Warm coolant from the engine cooling circuit thus heats charging air in the charging-air/coolant cooler. Furthermore, the cooling of the charging air may be limited in order to prevent the engine from cooling down under specific ambient conditions.

The separation of the two circuits during normal operation leads to a high cooling of the charging air and consequently to a high engine power and to low NOₓ fractions in the exhaust gas.

The invention is explained in detail below by means of an exemplary embodiment, with reference to the drawing.

The single FIGURE of the drawing shows a circuit arrangement 1 with a low temperature circuit 2 for the cooling of charging air and with an engine cooling circuit 3 (main circuit) for cooling an internal combustion engine, designated below as the engine 4.

The engine cooling circuit 3 comprises the engine 4, an engine thermostat 5, a coolant cooler 6 and a coolant pump 7. A feedline 8, the function of which is described in more detail at a later juncture, is provided from the mixed thermostat 5 to the low temperature circuit 2. A bypass 9 is provided between the engine thermostat 5 and the line between the coolant cooler 6 and coolant pump 7, so that coolant can be led past the coolant cooler 6.

The low temperature circuit 2 comprises a coolant pump 10, a mixed thermostat 11, in the present case an expansion thermostat, a charging-air/coolant cooler 12 and a low temperature cooler 13. The abovementioned feedline 8 issues into the mixed thermostat 11. Furthermore, a feedback line 14 is provided between the line downstream of the mixed thermostat 11 and upstream of the low temperature cooler 13 and downstream of the coolant cooler 6 and upstream of the coolant pump 8.

An air conveying device, indicated diagrammatically on the right of the coolant cooler 6 in the figure, with one or more sucking and/or delivering fans supplies the coolant cooler 6 and the low temperature cooler 13 with cooling air, the cooling air flowing first through the low temperature cooler 13 and subsequently through the coolant cooler 6.

The circuit arrangement 1 functions as follows. In a normal operating state, the coolant of the low temperature circuit 2 is heated relatively sharply when it flows through the charging-air/coolant cooler 12. In this case, the mixed thermostat 11 is closed with respect to the feedline 8, so that no coolant can pass from the engine cooling circuit 3 into the low temperature circuit 2, and there are two separate circuits, as is known from the prior art.

During the warm-up of the engine 4 or under other operating conditions in which the charging-air cooling has to be limited or the charging air even has to be heated up, the coolant leaves the charging-air/coolant cooler 12 at a relatively low temperature. In these situations, the mixed thermostat 11 opens with respect to the feedline 8, so that coolant can flow out of the engine coolant circuit 3 into the low temperature circuit 2. The coolant from the engine cooling circuit is, if appropriate, mixed in the mixed thermostat 11 with cold coolant from the low temperature circuit 2, which flows into the mixed thermostat 11 from the coolant pump 10, and is supplied to the charging-air/coolant cooler 12. The supply of coolant out of the engine cooling circuit 3 into the low temperature circuit 2 is compensated by means of a corresponding backflow of coolant out of the low temperature circuit 2 into the engine cooling circuit 3 via the feedback line 14.

In order to make it possible, out of normal operation, to heat up the charging air in regeneration phases of particle filters, the mixed thermostat 11 is opened with respect to the feedline 8, although the coolant leaves the charging-air/coolant cooler 12 in a relatively highly heated estate. In this case, electrically heating is provided in the mixed thermostat 11 designed as an expansion thermostat, heating taking place during normal operation. Switching off the heating by means of the engine electronics then leads to a corresponding influence being exerted on the expansion thermostat.

If a valve actuated by external energy is provided instead of an expansion thermostat, then, if required, external energy is activated as a result of a control signal.

### List of Reference Symbols

1 Circuit arrangement
2 Low temperature circuit
3 Engine cooling circuit
4 Engine
5 Engine thermostat
6 Coolant cooler
7 Coolant pump
8 Feedline
9 Bypass
10 Coolant pump
11 Mixed thermostat
12 Charging-air/coolant cooler
13 Low temperature cooler
14 Feedback line

1. A circuit arrangement with a low temperature circuit for the cooling of charging air in a motor vehicle comprising a turbocharger and an engine cooling circuit for cooling an engine, wherein the low temperature circuit can be temporarily coupled to the engine cooling circuit in such a way that coolant can pass from one circuit into the other circuit and back.

2. The circuit arrangement as claimed in claim 1, wherein a feedline between the engine cooling circuit (3) and the low temperature circuit is provided.

3. The circuit arrangement as claimed in claim 2, wherein the feedline leads from an engine thermostat, arranged in the engine cooling circuit downstream of the engine, as seen in the flow direction, to a mixed thermostat integrated into the low temperature circuit.

4. The circuit arrangement as claimed in claim 3, wherein a feedback line is arranged between the mixed thermostat and the engine thermostat.

5. The circuit arrangement as claimed in claim 2, wherein the mixed thermostat is an expansion thermostat or an electrically or pneumatically actuable valve.

6. A method for operating a circuit arrangement as claimed in claim 1, wherein, during the warm-up of the engine, coolant flows out of the engine cooling circuit into the low temperature circuit.

7. A method for operating a circuit arrangement as claimed in claim 1, wherein, in the warm state of the engine, coolant flows out of the engine cooling circuit into the low temperature circuit.

8. The method as claimed in claim 6, wherein warm coolant from the engine cooling circuit (3) is used for the heating of charging air in the charging-air/coolant cooler (12).

9. The circuit arrangement as claimed in claim 3, wherein the mixed thermostat is an expansion thermostat or an electrically or pneumatically actuable valve.

10. The circuit arrangement as claimed in claim 4, wherein the mixed thermostat is an expansion thermostat or an electrically or pneumatically actuable valve.

11. A method for operating a circuit arrangement as claimed in claim 2, wherein, during the warm-up of the engine, coolant flows out of the engine cooling circuit into the low temperature circuit.

12. A method for operating a circuit arrangement as claimed in claim 3, wherein, during the warm-up of the engine, coolant flows out of the engine cooling circuit into the low temperature circuit.

13. A method for operating a circuit arrangement as claimed in claim 4, wherein, during the warm-up of the engine, coolant flows out of the engine cooling circuit into the low temperature circuit.

14. A method for operating a circuit arrangement as claimed in claim 5, wherein, during the warm-up of the engine, coolant flows out of the engine cooling circuit into the low temperature circuit.

15. A method for operating a circuit arrangement as claimed in claim 2, wherein, in the warm state of the engine, coolant flows out of the engine cooling circuit into the low temperature circuit.

16. A method for operating a circuit arrangement as claimed in claim 3, wherein, in the warm state of the engine, coolant flows out of the engine cooling circuit into the low temperature circuit.

17. A method for operating a circuit arrangement as claimed in claim 4, wherein, in the warm state of the engine, coolant flows out of the engine cooling circuit into the low temperature circuit.

18. A method for operating a circuit arrangement as claimed in claim 5, wherein, in the warm state of the engine, coolant flows out of the engine cooling circuit into the low temperature circuit.

19. A method for operating a circuit arrangement as claimed in claim 6, wherein, in the warm state of the engine, coolant flows out of the engine cooling circuit into the low temperature circuit.

20. The method as claimed in claim 7, wherein warn coolant from the engine cooling circuit is used for the heating of charging air in the charging-air/coolant cooler.
